(19) United States
(12) Patent Application Publication
(10) Pub. No.: US 2013/0314224 A1
(43) Pub. Date: Nov. 28, 2013

(54) VEHICLE APPROACH NOTIFICATION UNIT

(71) Applicants: Hamanakodenso Co., Ltd., Kosai-city (JP); Denso Corporation, Kariya-city (JP)

(72) Inventors: Toshiaki NAKAYAMA, Miyoshi-city (JP); Koji SUZUKI, Hamamatsu-city (JP)

(73) Assignees: HAMANAKODENSO CO., LTD., Kosai-city (JP); DENSO CORPORATION, Kariya-city (JP)

(21) Appl. No.: 13/899,097

(22) Filed: May 21, 2013

(30) Foreign Application Priority Data
May 28, 2012 (JP) 2012-120899

(51) Int. Cl. B60Q 5/00

(52) U.S. Cl. CPC B60Q 5/00
USPC 340/463

(57) ABSTRACT

A vehicle approach notification unit disposed in a vehicle for producing a notification sound outside of the vehicle includes a small speaker producing the notification sound having an audible frequency. The small speaker is disposed on a sound tube of a horn of the vehicle, the horn producing a warning sound. The small speaker emits the notification sound into the sound tube, such that the notification sound is emitted from the vehicle via the sound tube. The small speaker is located in a midstream in a sound passage of the sound tube.

### CROSS REFERENCE TO RELATED APPLICATION

This application is based on Japanese Patent Application No. 2012-120899 filed on May 28, 2012, the disclosure of which is incorporated herein by reference in its entirety.

### TECHNICAL FIELD

The present disclosure relates to a vehicle approach notification unit.

### BACKGROUND

Conventionally, a vehicle approach notification unit notifies pedestrians of an approaching vehicle with a notification sound. For instance, JP-A-10-201001 discloses a vehicle approach notification unit having a dynamic speaker, which produces a sound with audible frequencies.

The notification sound, which notifies pedestrians of an approaching vehicle, is required not to be too loud, unlike a warning sound. In addition, an artificial engine sound, chords, voice sound, and music are preferable as the notification sound.

When the notification sound includes low frequencies under 600 Hz, the notification sound becomes quieter. Accordingly, in order to produce a quieter notification sound, or to produce an artificial engine sound that is close to the real engine sound, the notification sound is required to include such low frequencies.

Employing a dynamic speaker, such as a woofer that has a large diaphragm, such as a cone paper, may be used to produce low sound. However, a large space and extra costs are needed to employ such a large dynamic speaker.

In Japanese Patent Application No. 2011-238815 (U.S. patent application Ser. No. 13/662,913), a small speaker, which is a small dynamic speaker, such as a micro speaker, is mounted to a sound tube of a vehicle horn, which produces the warning sound, to produce the notification sound. The notification sound is emitted from a vehicle via the sound tube. Accordingly, low sound produced by the small speaker is amplified by the sound tube and emitted from the vehicle.

When the small speaker is mounted to the sound tube, the small speaker may be located at a horn inlet of the sound tube. For example, as shown in FIG. 5, a small speaker 100 is located at a horn inlet that is positioned at a center part of a sound tube 400, which has a spiral shape. That is, the small speaker 100 is located at the center of the spiral shape of the sound tube 400.

A warning sound generator, (i.e., a frequency generator of a vehicle horn), produces a very loud warning sound with high pressure. The warning sound generator also produces a highly compressed pressure wave that produces the warning sound toward the horn inlet.

Accordingly, when the small speaker is mounted to the horn inlet, the highly compressed pressure wave impacts the small speaker, and may break the small speaker. Furthermore, a back electromotive force produced by the small speaker may break an amplifier actuating the small speaker.

### SUMMARY

It is an object of the present disclosure to provide a vehicle approach notification unit in which a small speaker mounted to a vehicle horn for producing a notification sound is positioned to withstand a highly compressed pressure wave produced by a warning sound generator of the vehicle horn.

According to an example of the present disclosure, a vehicle approach notification unit is disposed in a vehicle for producing a notification sound outside of the vehicle, and includes a small speaker producing the notification sound having an audible frequency. The small speaker is disposed on a sound tube of a horn of the vehicle, the horn producing a warning sound. The small speaker emits the notification sound into the sound tube, such that the notification sound is emitted from the vehicle via the sound tube. The small speaker is located in a midstream in a sound passage of the sound tube.

### BRIEF DESCRIPTION OF THE DRAWINGS

The above and other objects, features and advantages of the present disclosure will become more apparent from the following detailed description made with reference to the accompanying drawings. In the drawings:

FIG. 1A is a schematic front view illustrating a vehicle approach notification unit according to an embodiment;

FIG. 1B is a schematic cross-sectional view illustrating a position of a small speaker in a sound passage of a sound tube of a vehicle horn;

FIG. 2 is a cross-sectional view illustrating the vehicle approach notification unit;

FIG. 3 is a block diagram illustrating the vehicle approach notification unit;

FIG. 4 is an explanatory drawing illustrating a determination of the position of the small speaker where (a) is a graph illustrating a relationship between a sound pressure at a horn outlet of the sound passage and a distance from a horn inlet of the sound passage to a hole defined in the sound tube, (b) is an explanatory view illustrating a position of the hole in the sound tube having a rolled out shape, and (c) is a graph illustrating sound density distribution pattern in the sound tube; and

FIG. 5 is a front view illustrating a vehicle horn with a small speaker mounted therein according to a related art.

### DETAILED DESCRIPTION

The present disclosure will be described hereafter with reference to the drawings. In the embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

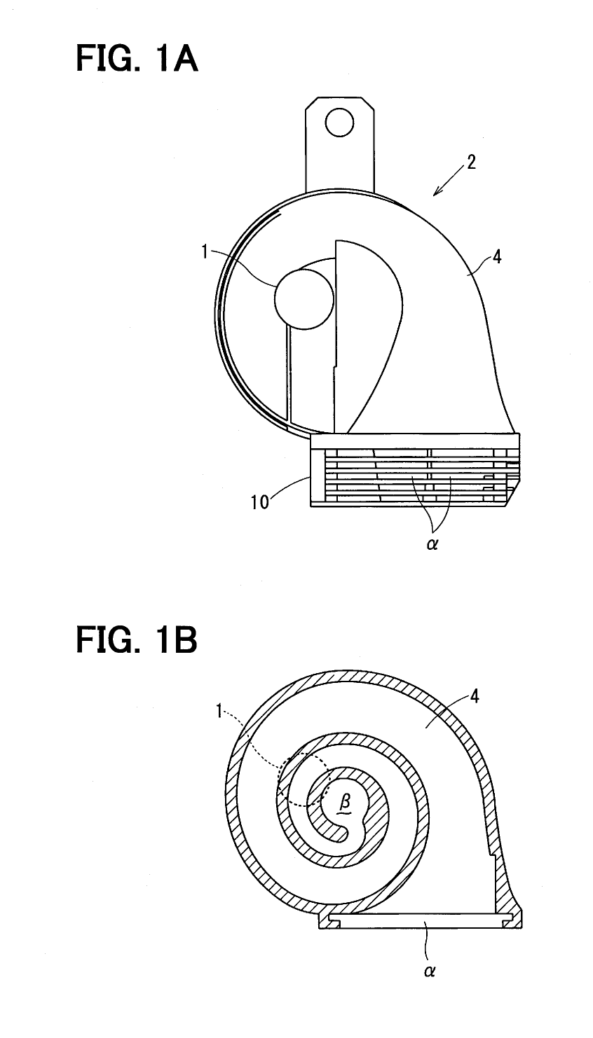

An embodiment will be described with reference to FIGS. 1A to 4.

A vehicle approach notification unit is disposed in a vehicle that may emit a quite sound during a drive time or a stop time. For example, the vehicle may be an electric vehicle or a fuel cell vehicle with no engine (i.e., no internal combustion engine). Also the vehicle may be a hybrid vehicle in which the engine is stopped at the drive time and the stop time, an idling stop vehicle in which the engine is stopped at the stop time, or an engine vehicle that drives quietly.

The vehicle may include a vehicle horn 2, which works as a warning unit and produces a warning sound. When an occupant operates a horn switch, such as a horn button on a steering wheel, the vehicle horn 2 produces the warning sound. The vehicle horn 2 may be disposed between, for example, a front grille and a heat exchanger. The front grille is located to an air intake port that receives and draws a flow of outside air generated when the vehicle drives, and the heat exchanger is used for an air-conditioner, such as radiator.

Although a mechanism of the vehicle horn 2 is not limited, according to the embodiment, an electromagnetic warning device is employed as an example.

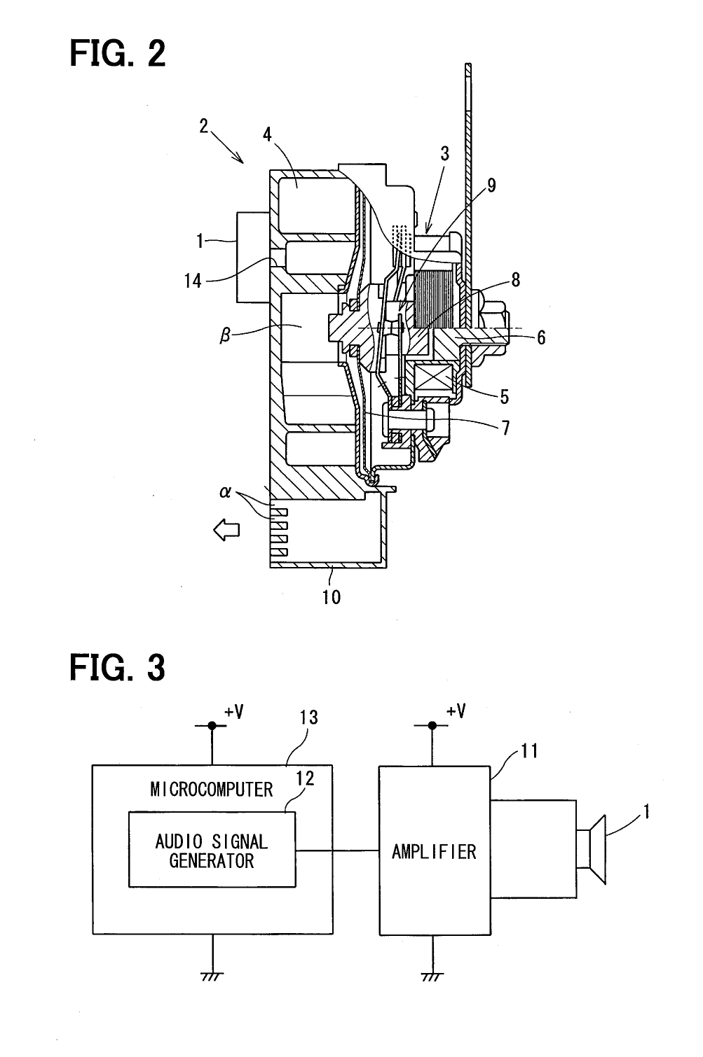

As shown in FIG. 2, the vehicle horn 2 includes a warning sound generator 3 and a sound tube 4 that has a spiral shape. The warning sound generator 3 produces the warning sound. The sound tube 4 amplifies the warning sound, and emits an amplified warning sound.

The warning sound generator 3 includes well-known components, such as a coil 5, a fixed iron-core 6, a moveable iron-core 8, and a current interrupter 9. The coil 5 creates magnetic energy when current is applied thereto. The fixed iron core 6 generates a magnetic force that attracts and moves the moveable iron-core 8 toward the fixed iron-core 6. At some point when the moveable iron core 8 reaches the fixed iron core 6, the current interrupter 9 interrupts the current flowing in the coil 5, which stops the generation of the magnetic force and the moveable iron core 8 moves away from the fixed iron core 6. The fixed iron-core 6 may be an attraction core, which creates magnetic attracting force when the magnetic energy is produced by the coil 5. The moveable iron-core 8 is supported at a center of a diaphragm 7 and moves towards the fixed iron-core 6 when the magnetic attracting force is generated. The current interrupter 9 intermittently interrupts the energization current in the coil 5 based on the position of the moveable iron-core 8 relative to the fixed iron-core 6.

The sound tube 4 has a trumpet portion in which a sound passage is enlarged from a horn inlet β to a horn outlet α. The horn inlet β is a sound inlet, and the horn outlet α is a sound outlet. Sound generated by the warning sound generator 3 enters the trumpet portion from the horn inlet β and comes out of the horn outlet α. Moreover, the sound tube 4 is defined by a spiral horn, which is produced by forming the trumpet portion into a spiral shape. An open end of the sound tube 4 defines the horn outlet α.

The warning sound generator 3 is attached to a side face of the sound tube 4, and is arranged to generate the warning sound into the horn inlet β, which is at the center of the sound tube 4. The warning sound generator 3 produces a highly compressed pressure wave as the warning sound. The side face of the sound tube 4 having the warning sound generator 3 is perpendicular to an axis of the spiral shape. For example, when the vehicle horn 2 is attached to the vehicle, the side face of the sound tube 4 faces a rear side of the vehicle.

As shown in FIGS. 1A and 2, a directivity controller 10 may be mounted to the horn outlet a of the sound tube 4, but is not limited to the example. When the sound tube 4 emits sound such as the warning sound and the notification sound, the directivity controller 10 controls directivity of the sound to be heard in front of the vehicle.

When a predetermined driving condition to notify pedestrians of an approaching vehicle is met, the vehicle approach notification unit produces a notification sound, such as artificial engine sound, chord, voice sound and music. As shown in FIG. 3, the vehicle approach notification unit includes the small speaker 1, an amplifier 11, and a microcomputer 13. The microcomputer 13 includes an audio signal generator 12 that applies an audio signal, which is a basis of the notification sound, to the amplifier 11. The amplifier 11 actuates the small speaker 1, and the small speaker 1 produces the notification sound. The audio signal may be an analog signal or a digital signal.

An engine control unit (ECU) inputs a signal, which includes driving vehicle information such as a vehicle speed, to the microcomputer 13. Based on the driving vehicle information, the microcomputer 13 determines whether the predetermined driving condition is met or not to notify pedestrians of the approaching vehicle. For example, the predetermined driving condition may be the vehicle speed that is under 20 km/h. When the predetermined driving condition is met, the microcomputer 13 actuates the audio signal generator 12 to apply the audio signal to the amplifier 11. The amplifier 11 then actuates the small speaker 1 to produce the notification sound.

The amplifier 11 amplifies the audio signal produced by the audio signal generator 12, and actuates the small speaker 1 with an amplified audio signal. A B-grade amplifier or a D-grade amplifier can be used as the amplifier 11. By controlling a signal applied to the small speaker 1, the amplifier 11 actuates the small speaker 1 to produce a frequency that generates the notification sound. In other words, the small speaker 1 produces an audible frequency that produces an audible sound.

The small speaker 1 is a micro-speaker, which has a few centimeter in diameter. According to the embodiment, a piezoelectric speaker is employed as an example of the small speaker 1. The piezoelectric speaker includes a piezoelectric element and a diaphragm. The piezoelectric element is displaced by the expansion or contraction depending on the applied voltage (charge/discharge). The diaphragm is actuated by the displacement of the piezoelectric element, and creates compressed waves in the air.

The piezoelectric speaker has a vibration system constructed by the piezoelectric element and the diaphragm, and produces an audible frequency sound.

A primary resonance frequency of the vibration system is in the audible range, for example, about 2 kHz.

Because the diaphragm in the small speaker 1 is small in area, it is difficult for the small speaker 1 to produce air vibrations with a low frequency. In other words, it is difficult for the small speaker 1 to produce a low sound. The small speaker 1, which is attached to the sound tube 4, emits the notification sound through the sound tube 4, and the sound tube 4 outputs the notification sound.

By having the small speaker 1 attached to the sound tube 4, the sound tube 4 regulates the compression waves produced by the small speaker 1, and emits the compression waves out with less attenuation in the air vibration as a low frequency sound. Due to the sound tube 4, the sound pressure of the low frequency sound can be enhanced even when the small speaker 1 is employed, and a notification sound can be produced with the amplified low sound.

As discussed earlier, the small speaker 1 can be located on the horn inlet β, which is located at the center of the vehicle horn 2 having the spiral shape. However, if the small speaker 1 is located on the horn inlet β, the highly compressed pressure wave produced by the warning sound generator 3 may impact the small speaker 1. In other words, the small speaker 1 may be damaged by the highly compressed pressure wave produced by the warning sound generator 3. Moreover, the amplifier 11 may be broken by a back electromotive force produced by the small speaker 1.

Furthermore, the horn inlet β is located at a place at which the highly compressed pressure wave is at its highest level as it travels in the sound tube 4. If the small speaker 1 is attached directly at the horn inlet β, the small speaker 1 absorbs a part of the highly compressed pressure waves, thereby decreasing the sound pressure of the warning sound.

In contrast, according to the embodiment, as shown in FIG. 1B, the small speaker 1 is located near the horn inlet β of the sound tube 4, and is not on or directly at the horn inlet β, thereby restricting the impact of the highly compressed pressure waves on the small speaker 1. Specifically, the small speaker 1 is attached to the sound tube 4 at some midstream location along the sound passage, and the small speaker 1 emits a notification sound into the sound tube 4 through a hole 14 defined in the sound tube 4.

When the warning sound generator 3 produces the warning sound, the warning sound has a sound density that includes a dense range and a non-dense range inside the sound tube 4. The small speaker 1 is attached in the non-dense range and in the vicinity of the horn inlet β, then the sound tube 4 amplifies the notification sound emitted into the sound tube 4 effectively.

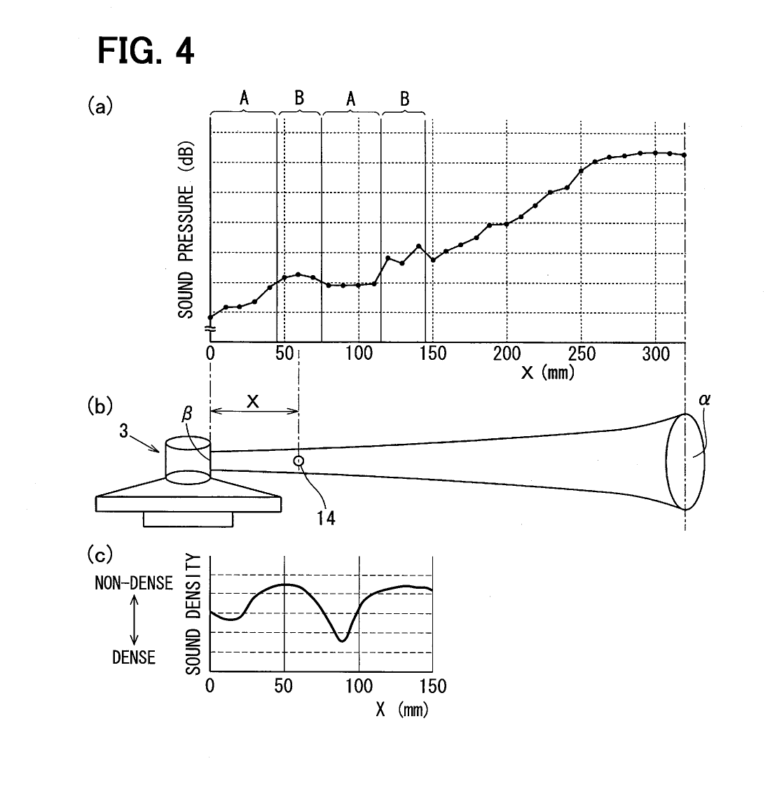

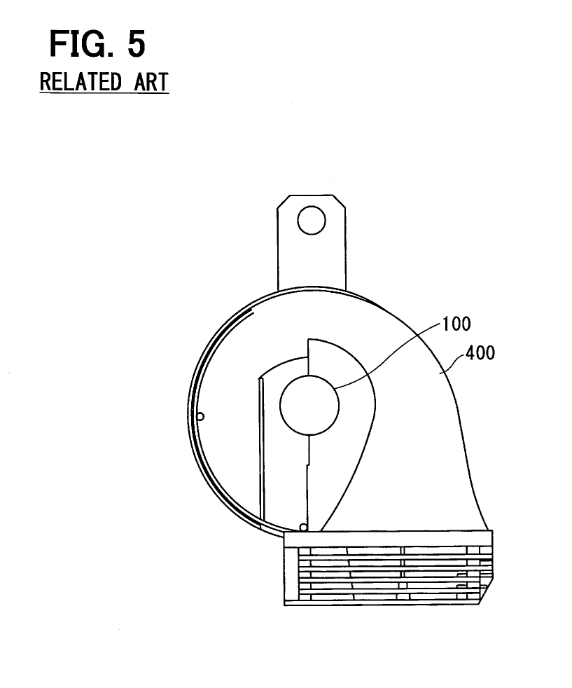

The mounting location of the small speaker 1 will be described in more details with reference to FIG. 4. The warning sound is defined to have a basic sound frequency f Hz, which determines a tone of the warning sound, and a wavelength of λ mm. The mounting location of the small speaker 1 is away from the horn inlet β by a distance in a range from (λ/4−15) mm to (λ/4+15) mm. For instance, when the wavelength λ is 240 mm (λ=240), the small speaker 1 is located away from the horn inlet β by a distance in a range from 45 mm to 75 mm.

A relationship between the mounting location of the small speaker 1 and performance degradation of the vehicle horn 2 is described with reference to (a) of FIG. 4. In particular, (a) of FIG. 4 provides the relationship between the mounting location of the hole 14 to which the small speaker 1 is mounted and the lowering in the sound pressure of the warning sound when the sound pressure is measured at the horn outlet α.

In determining the mounting location of the smaller speaker 1, the hole 14 defined in the sound tube 4, which is 2 mm in diameter, is positioned along the sound tube 4 to emit a frequency whose wavelength is 240 mm. To be understood, the sound tube 4 is drawn with a rolled out shape as shown in (b) of FIG. 4. Next, the location of the hole 14 is changed from the horn inlet β toward the horn outlet α in 10 mm increments, and a sound pressure of the warning sound is measured at the horn outlet α. As shown in (b) of FIG. 4, a distance between the horn inlet β and the hole 14 is represented by “X”.

The small speaker 1 is mounted to emit the notification sound in the sound tube 4 through the hole 14. That is, as shown in FIG. 2, the location of the hole 14 corresponds to the location of the small speaker 1. Accordingly, the distance X is equal to a distance between the horn inlet β and the small speaker 1, and the graph in (a) of FIG. 4 shows a relationship between the distance X and the sound pressure of the warning sound at the horn outlet α.

As shown in (a) of FIG. 4, the sound pressure continuously increases after the distance X exceeds 150 mm. In the vicinity of the horn inlet β, in which the distance X is shorter than 150 mm, there are two kind of ranges, a range A and a range B. As shown in (a) of FIG. 4, by having the hole 14, the sound pressure of the waning sound is decreased substantially when the hole 14 is located in the range A. In contrast, when the hole 14 is located in the range B, the sound pressure of the warning sound is restricted from decreasing even when the sound tube 4 had the hole 14.

To support the above description, a graph in (c) of FIG. 4 shows a typical pattern of sound density distribution inside the sound tube 4 in a range where the distance X is 0 to 150 mm. In the range A, the sound density becomes dense. In contrast, the sound density becomes sparse (non-dense) in the range B.

Here, the range A may correspond to the dense range of the warning sound in the sound passage, and the range B may correspond to the non-dense range of the warning sound in the sound passage.

Therefore, the sound pressure may not decrease substantially even when the sound tube 4 has the hole 14 in the range B. In contrast, the sound pressure decreases when the sound tube 4 has the hole 14 in the range A.

The range B is located at two places in a section where the distance X is smaller than 150 mm. A first place of the range B is from X=50 to X=70, and a second place of the range B is from X=120 to X=140.

In the present embodiment, the mounting location of the small speaker 1 is within the first place of the range B which is adjacent to the horn inlet β, and the smaller speaker 1 is mounted at a position where the sound pressure decrease is the smallest in the first place of the range B which is adjacent to the horn inlet β.

For instance, when the distance X is equal to 60 (X=60 mm) within the first place of the range B adjacent to the horn inlet β, the sound pressure decrease is the smallest. Thus, the small speaker 1 is mounted to the sound tube 4 at a position where the distance X is equal to 60.

As shown in FIG. 2, the small speaker 1 is mounted on an opposite side of the warning sound generator 3 with respect to the sound tube 4. For example, the warning sound generator 3 is mounted on a back side of the sound tube 4, and the small speaker 1 is mounted on a front side of the sound tube 4. These mounting directions of the small speaker 1 are just example.

To sum up, the vehicle approach notification unit of the present disclosure can be described as follows.

The vehicle approach notification unit includes the small speaker 1 that produces a notification sound directly. When a predetermined driving condition is met to notify pedestrians of an approach of the vehicle, the vehicle approach notification unit produces the notification sound, which is audible outside the vehicle.

The small speaker 1 and the warning sound generator 3 are both disposed on the vehicle horn 2 at different locations. The sound tube 4 of the vehicle horn 2 has the small speaker 1 arranged thereon, and the small speaker 1 emits the notification sound into the sound tube 4. The sound tube 4 has a spiral shape.

The mounting location of the small speaker 1 on the sound tube 4, in other words, a location in which the small speaker 1 emits the notification sound into the sound tube 4, is located at some midstream point in the sound passage. The small speaker 1 is positioned in the non-dense range of the warning sound in the sound density.

According to the embodiment, the vehicle approach notification unit has the small speaker 1 attached on the sound passage of the sound tube 4. At the mounting location, the small speaker 1 emits the notification sound into the sound tube 4.

Specifically, the warning sound has a sound density distribution including the dense range and the non-dense range inside the sound tube 4, and the mounting location of the small speaker 1 is in the non-dense range. Furthermore, the mounting location of the small speaker 1 is in the vicinity of the horn inlet β, in which the sound tube 4 amplifies a notification sound effectively. More specifically, the small speaker 1 is located away from the horn inlet β by a distance in a range from (λ/4−15) mm to (λ/4+15) mm. At the time, the small speaker 1 is located in the non-dense range and is in the vicinity of the horn inlet β.

Accordingly, when the warning sound generator 3 produces the highly compressed pressure waves to generate the warning sound, the highly compressed pressure waves may be restricted from damaging the small speaker 1. Therefore, the small speaker 1 and the amplifier 11 may be protected from the highly compressed pressure waves.

In other words, the small speaker 1 is located in the non-dense range of warning sound density, so that the highly compressed pressure waves may be restricted from having an impact on the small speaker 1 and the amplifier 11.

Thus, reliability and durability of the small speaker 1 and the amplifier 11 mounted to the vehicle horn 2 is improved. That is, reliability of the vehicle approach notification unit, in which the small speaker 1 produces a notification sound and the notification sound is emitted out via the sound tube 4 mounted to the vehicle horn 2, may be improved.

According to the embodiment, the piezoelectric speaker producing audible sound is employed as an example of the small speaker 1. A piezoelectric speakers is a non-expensive versatile speaker, so a cost for producing the vehicle approach notification unit may decrease.

A piezoelectric speaker is smaller and lighter than a cone speaker, so a piezoelectric speaker may be mounted to the vehicle horn 2 easily, and the vehicle horn 2 including the piezoelectric speaker may be mounted to the vehicle easily.

Although the sound tube 4 is employed as a sound tube and has one small speaker 1 according to the embodiment, a sound tube may mount a plurality of the small speakers 1 to enhance the sound pressure of the notification sound. In such a case, the plurality of the small speakers 1 may be located in the non-dense range of warning sound in the sound density.

Although a piezoelectric speaker is employed as an example of the small speaker 1 according to the embodiment, other speakers, which are small in diameter and emit audible sound directly, such as a cone speaker having a small diameter, may be applicable.

Although the small speaker 1, which is a kind of a dynamic speaker producing audible sound directly, produces a notification sound according to the embodiment, a parametric speaker may be mounted together. In such a case, the small speaker 1 produces the notification sound via the sound tube 4, and the parametric speaker also produces a notification sound. Accordingly, both of the notification sounds may be emitted together from the vehicle.

When the warning sound generator 3 is actuated, the small speaker 1 may be actuated at the same time. In such a case, a tone of a warning sound; in other words, a frequency of the warning sound, may be controlled by actuating the small speaker 1.

When the small speaker 1 produces a notification sound, the waning sound generator 3 may be actuated as a dynamic speaker by voltage that does not actuate the current interrupter 9 intermittently. In such a case, the small speaker 1 and the warning sound generator 3 produce notification sounds at the same time.

Such changes and modifications are to be understood as being within the scope of the present disclosure as defined by the appended claims.

What is claimed is:

1. A vehicle approach notification unit disposed in a vehicle for producing a notification sound outside of the vehicle, the vehicle approach notification unit comprising:
a small speaker producing the notification sound having an audible frequency, wherein
the small speaker is disposed on a sound tube of a horn of the vehicle, the horn producing a warning sound,
the small speaker emits the notification sound into the sound tube, such that the notification sound is emitted from the vehicle via the sound tube, and
the small speaker is located in a midstream in a sound passage of the sound tube.

2. The vehicle approach notification unit according to claim 1, wherein
the sound tube has a spiral shape, and
the small speaker is positioned near a center of the spiral shape, and not on the center of the spiral shape.

3. The vehicle approach notification unit according to claim 1, wherein
the sound passage of the sound tube has a non-dense range and a dense-range in a sound density when the horn produces the warning sound, and
the small speaker is positioned in the non-dense range.

4. The vehicle approach notification unit according to claim 1, wherein
the horn has a base sound frequency off Hz for the warning sound, and
the small speaker is positioned away from a horn inlet of the sound tube by a distance that is within a range from (λ/4−15) mm to (λ/4+15) mm, where λ mm is a wavelength of the warning sound.

5. The vehicle approach notification unit according to claim 1, wherein
the small speaker is a piezoelectric speaker producing an audible sound.
